(19) United States
(12) Patent Application Publication
(10) Pub. No.: US 2010/0263476 A1
(43) Pub. Date: Oct. 21, 2010

(54) ADJUSTABLE HANDLE FOR WINCH AND JACK

(76) Inventor: Joseph J. Peschmann, Plover, WI (US)

Correspondence Address: MCDONALD HOPKINS LLC, 600 Superior Avenue, East, Suite 2100, CLEVELAND, OH, 44114-2653, US

(21) Appl. No.: 12/636,147

(22) Filed: Dec. 11, 2009

Related U.S. Application Data
(60) Provisional application No. 61/201,543, filed on Dec. 11, 2008.

(51) Int. Cl. G05G 1/10; G05G 1/00

(52) U.S. Cl. 74/546

(57) ABSTRACT

An adjustable handle assembly for adjusting a winch or jack is described. The handle assembly may include a crank bar a slide bracket and a grip. The crank bar may include an attachment aperture and adjustment aperture, wherein the attachment aperture may be attachable to a shaft of a winch or jack. The slide bracket may include at least one slot, such as a pair of slots, and a grip aperture, wherein the slide bracket may be capable of engagement the said crank bar forming an overall length of the handle assembly. The grip may be attachable to the grip aperture. There may be at least one fastener capable of engagement with the adjustment aperture and either of the first slot or the second slot. The crank bar may be adjustable along a length of the either the first slot or the second slot.

### CROSS-REFERENCE TO RELATED APPLICATION

This application claims benefit from U.S. Provisional Patent Application No. 61/201,543, entitled “Adjustable Handle For Winch And Jack,” filed on Dec. 11, 2008, which is hereby incorporated in its entirety by reference.

### FIELD OF THE INVENTION

The present invention relates generally to winches and jacks and, more particularly, to handles for winches and jacks that are adjustable.

### BACKGROUND

Towed vehicles or trailers are often designed to secure and haul cargo. Trailers may be arranged to haul specific types of cargo such as boats, automobiles, consumer products, and the like. Many such cargo items are heavy and difficult to move or maneuver onto the bed or frame of a towing trailer. To assist in moving or maneuvering cargo onto a towing trailer, such trailers are often equipped with a trailer winch assembly, whereby the winch assembly may commonly be attached to the tongue of the trailer. The winch may be connected to a cargo item by, for example, a strap, cable, rope, or chain for pulling the cargo item onto the trailer. There may also be brake or work winches that may be used for lifting or pulling.

The winch assembly may typically use a winch handle to rotate a drum thereby winding the strap or cable around the drum and thus pulling the cargo item towards the winch and onto the trailer. The winch assembly may also be used to unload a heavy item by rotating the drum in the opposite direction to unwind a strap or chain to allow the cargo item to be safely and easily slid off of the trailer.

Trailers are commonly supported by trailer jacks. Such jacks may typically be securable to the trailer tongue to support the trailer in a horizontal position when the trailer is uncoupled from a towing vehicle. Trailer jacks may also include jack handles. These jack handles may be of a similar form and function to winch handles that may be arranged to be manually rotated to raise and lower the tongue portion of a trailer.

Winch handles and jack handles may typically be manufactured or fabricated for specific winches or jacks or for specific applications and may not allow for any modification in the configuration or operation of the handle.

### SUMMARY

An adjustable handle assembly for adjusting a winch or jack is described. The handle assembly may include a crank bar a slide bracket and a grip. The crank bar may include an attachment aperture and adjustment aperture, wherein the attachment aperture may be attachable to a shaft of a winch or jack. The slide bracket may include at least one slot, such as a pair of slots, and a grip aperture, wherein the slide bracket may be capable of engagement the said crank bar forming an overall length of the handle assembly. The grip may be attachable to the grip aperture. There may be at least one fastener capable of engagement with the adjustment aperture and either of the first slot or the second slot. The crank bar may be adjustable along a length of the either the first slot or the second slot. The handle assembly may be lengthened to increase a force applied to the winch or jack. The handle assembly may be shortened to accommodate rotation of the handle assembly within a tight space.

### BRIEF DESCRIPTION OF THE DRAWINGS

Objects and advantages together with the operation of the embodiments disclosed herein may be better understood by reference to the detailed description taken in connection with the following illustrations, wherein:

FIG. 1 illustrates a perspective view of a handle assembly.

FIG. 2 illustrates an exploded perspective view of components of a handle assembly.

FIG. 3A illustrates a front view of an adjustable slide bracket.

FIG. 3B illustrates a side view of the adjustable slide bracket of FIG. 3A.

FIG. 3C illustrates a top view of the adjustable slide bracket of FIG. 3A.

FIG. 3D illustrates a bottom perspective view of the adjustable slide bracket of FIG. 3A.

FIG. 4A illustrates a top view of a crank bar.

FIG. 4B illustrates a front view of the crank bar of FIG. 4A.

FIG. 4C illustrates a side view of the crank bar of FIG. 4A.

FIG. 5 illustrates a perspective view of a partially assembled handle assembly.

FIG. 6 illustrates a perspective view of a partially assembled handle assembly.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

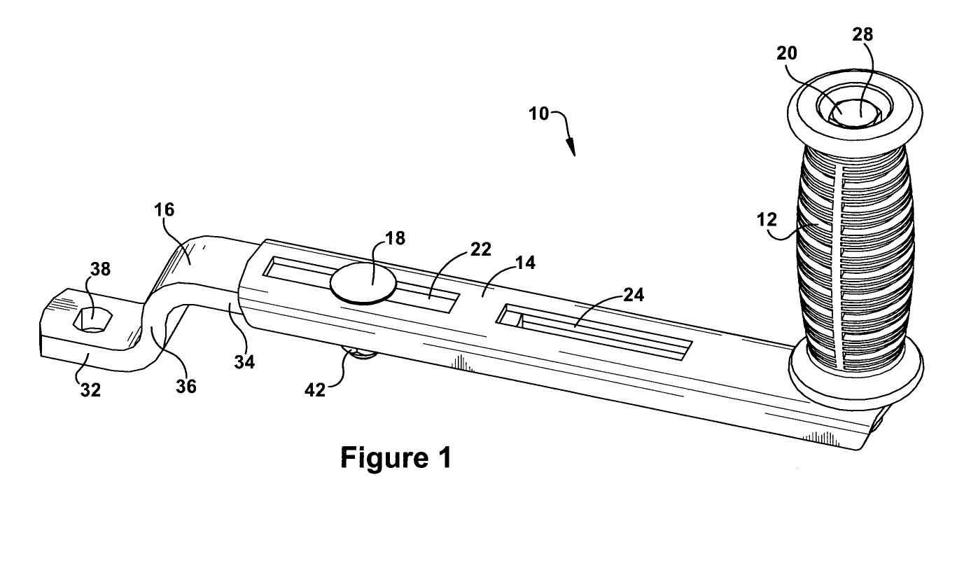

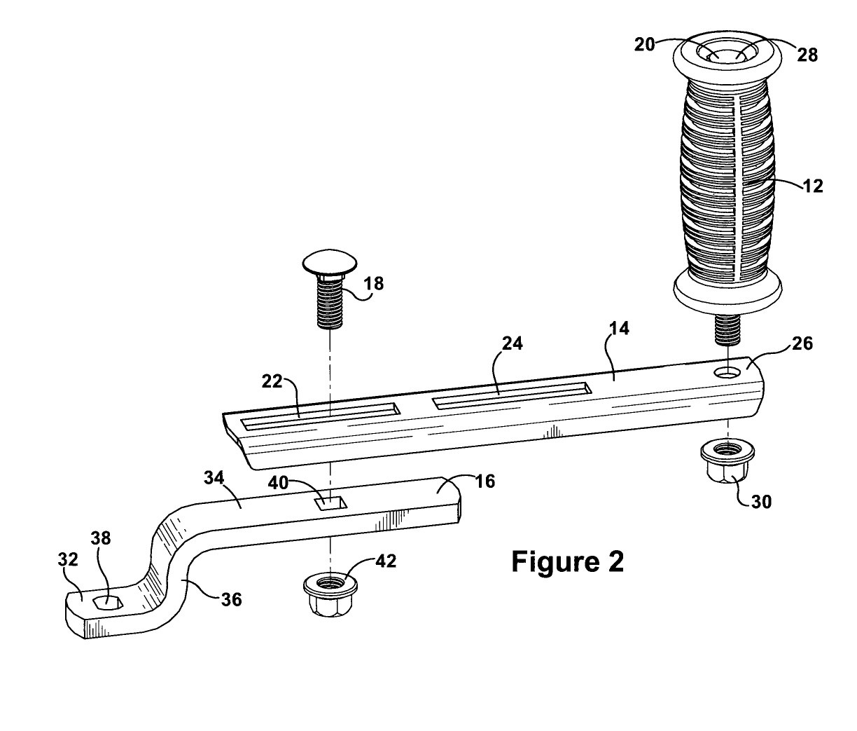

An adjustable handle assembly 10 for use with a winch, such as a trailer or brake winch, or jack is illustrated in FIGS. 1 and 2. The adjustable handle assembly 10 may provide flexibility in its arrangement or configuration for winch and jack handles. This flexibility may allow for a winch handle or jack handle 10 to accommodate any appropriate type of winch or jack or for any appropriate shape, size, or type of handle to accommodate a single winch or jack that may be used for any variety of purposes and in any variety of situations. The adjustable handle assembly 10 may include a handle grip 12, an adjustment slide bracket 14, a crank bar 16, and a fastener 18 (FIGS. 1, 2, 5 and 6). The fastener 18 may secure the adjustable slide bracket 14 to the crank bar 16. The grip 12 may be secured to the slide bracket 14 by a grip fastener 20.

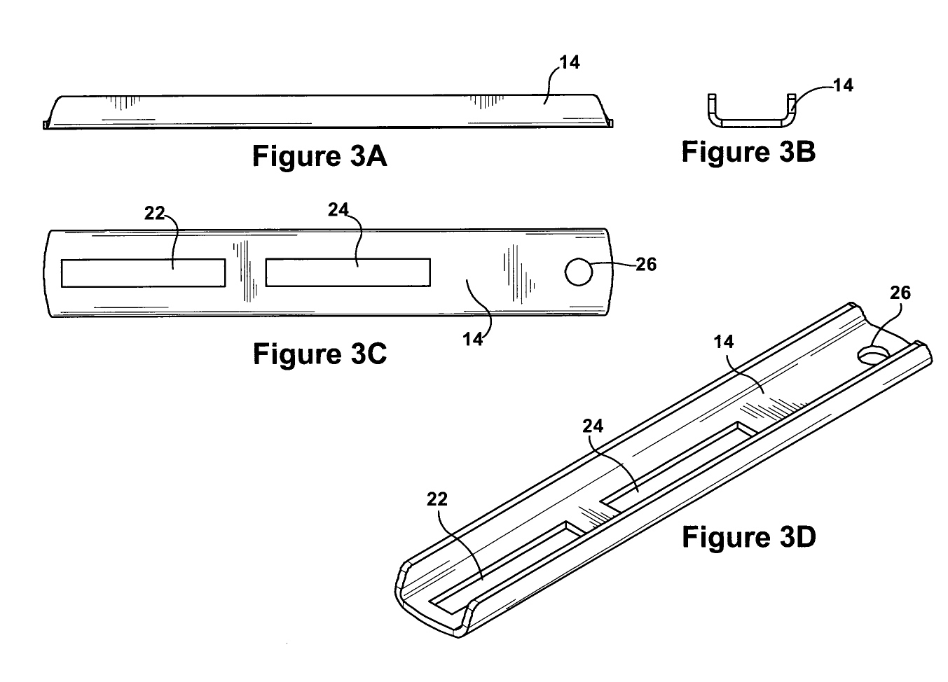

The slide bracket 14 may be of any appropriate shape or size, such as a generally rectangular or square shape (FIGS. 3A-3D). The slide bracket 14 may include at least one slot. For example, the slide bracket 14 may include a pair of slots 22, 24 (FIGS. 1, 2, 3C, 3D, 5 and 6). The slots 22, 24 may be of any appropriate shape or size, such as a generally square, rectangular, ovular or circular shape. The slots 22, 24 may each be of a correspondingly similar shape and size or the slots 22, 24 may be of differing shapes and sizes. The slots 22, 24, may be located at any appropriate position on the slide bracket 14, such as where one slot 22 is located towards one end and the other slot 24 is located towards an other end of the slide bracket 14. For example, the slots 22, 24 may run longitudinally along the bracket 14 and along an approximate center line of the slide bracket 14.

The slide bracket 14 may include a grip aperture 26 (FIGS. 2, 5 and 6). The aperture 26 may be of any appropriate shape or size, such as a generally circular, ovular or square shape. The aperture 26 may be located at any appropriate position on the slide bracket 14, such as being located adjacent to an end of the bracket 14 (FIGS. 3A-3D). For example, the aperture 26 may be located at the end opposite that of the first slot 22.

The slide bracket 14 may also include at least one flange 44 (FIGS. 3B and 3D). For example, the bracket 14 may include a pair of flanges 44. The flanges 44 may be of any appropriate shape or size, such as a generally rectangular or square shape. The flanges 44 may be located at any appropriate position on the slide bracket 14. For example, the flanges 44 may be located on either side of the slide bracket 14 whereby the flanges 44 may be located generally opposite of one another. The flanges 14 may extend generally perpendicularly outward from the slide bracket 14, whereby the slide bracket 14 may be of an approximate C-shape.

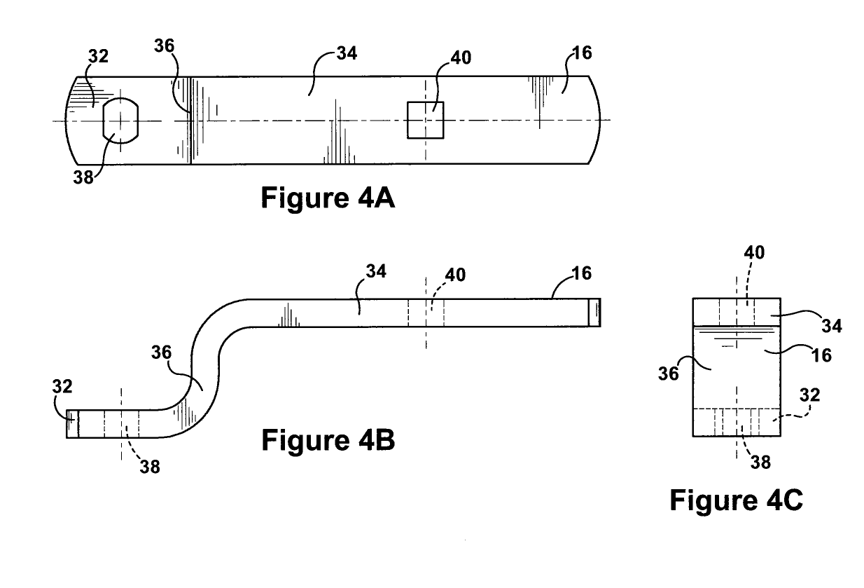

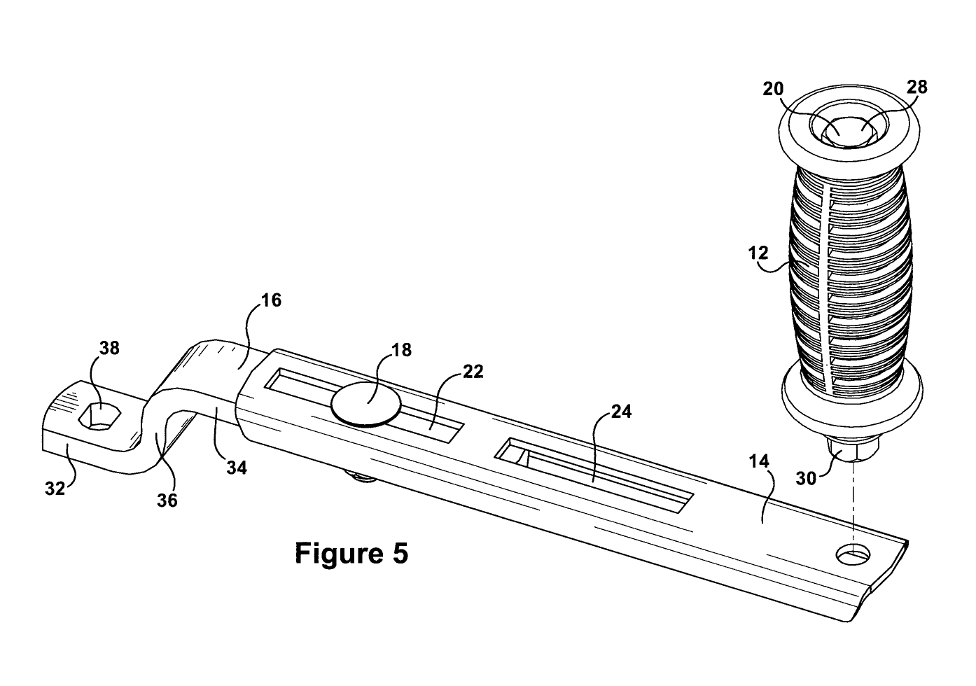

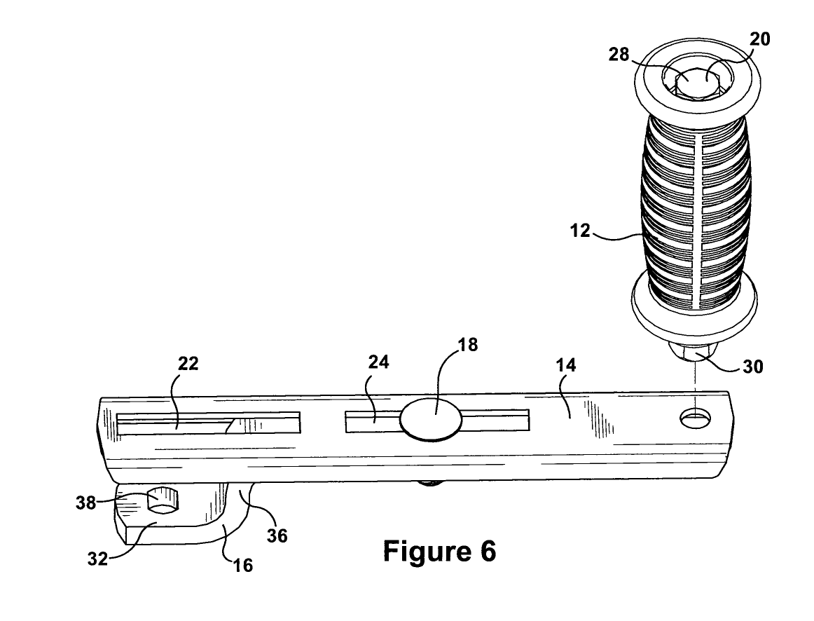

The crank bar 16 may be of any appropriate shape or size, such as of a generally rectangular planar, dog-leg or S-shape (FIGS. 4A-4C). The crank bar 16 may include a first linear portion 32, a second linear portion 34, and a transition portion 36. The first linear portion 32 may be of any appropriate shape or size and may be located at any appropriate location on the crank bar 16. For example, the first linear portion 32 may be generally shorter than the second linear portion 34 and may be located towards a first end of the crank bar 16. The crank bar 16 may fit into the general C-shape of the slide bracket 14, whereby the crank bar 16 may be in sliding engagement with the slide bracket 14 (FIGS. 5 and 6).

The first linear portion 32 may include an attachment aperture 38 (FIG. 4A). The aperture 38 may be of any appropriate shape or size, such as a generally rectangular, square, circular or ovular shape. The aperture 38 may be located at any appropriate position on the crank bar 16, such as at the approximate center of the first linear portion 32. The aperture 38 of the first liner portion 32 may generally be utilized to secure the handle assembly 10 to a shaft that may drive a drum of any appropriate type of winch or jack (shaft, drum, winch, and jack not shown). It is to be understood that the handle assembly 10 may be attached or secured to a shaft of the drum, such as of a winch or jack, by any appropriate means, such as via fasteners, means that do not require fasteners, spring loaded clips, and the like, and should not be limited to that shown or described herein.

The handle assembly 10 may be secured to the trailer winch or jack such that rotation of the handle assembly 10 may make the winch operable to pull or otherwise move objects, such as cargo, or to make the jack operable to adjust the height of a trailer. The handle assembly 10 may also be secured to a brake or work winch to aid in pulling or lifting. While described herein as being used with a trailer winch, brake winch, or jack, it is to be understood that the handle assembly 10 may be used with any appropriate type of device or apparatus that may have use for a handle and should not be limited to those described herein.

The transition portion 36 may be of any appropriate shape or size and be located at any appropriate position on the crank bar 16. For example, the transition portion 36 may be disposed between and connect the first linear portion 32 and second linear portion 34 (FIG. 4B). The transition portion 36 may be of a generally curved shape to connect the first linear portion 32 and second linear portion 34 linear portion. It is to be understood, however, that the transition portion 36 may be of any variety of shapes that may connect the first linear portion 32 and second linear portion 34 to one another.

The second linear portion 34 may be of any appropriate shape or size and may be located at any appropriate position on the crank bar 16. For example, the second linear portion 34 may be generally longer than the first linear portion 32 and may be located towards a second end of the crank bar 16. As another alternative, the first linear portion 32 may be generally longer than the second linear portion 34 and may be located towards a second end of the crank bar 16. The second linear portion 34 may also include an adjustment aperture 40 (FIGS. 2 and 4A). The aperture 40 may be of any appropriate shape or size, such as a generally rectangular, square, circular or ovular shape. The aperture 40 may be located at any appropriate position on the crank bar 16, such as at the approximate center of the second linear portion 34.

The aperture 40 in the second linear portion 34 may generally be utilized to secure the crank bar 16 to the adjustable slide bracket 14. For example, the crank bar 16 may be secured to the adjustable slide bracket 14 by a fastener 18 (FIGS. 1, 2, 5 and 6). The fastener 18 may pass though both the aperture 40 in the second linear portion 34 and either one of the slots 22, 24 in the adjustable slide bracket 14. The fastener 18 may be of any appropriate shape, size or type, such as a screw, bolt or the like.

For example, the fastener 18 may be a threaded bolt, and the attachment of the crank bar 16 to the adjustable slide bracket 14 may be completed by threading another fastener, such as a nut 42 or other such mechanism, onto the bolt 18. It is to be understood that in such an arrangement the threaded fastener 18 may be passed through the aperture 40 and either one of the slots 22, 24, whereby the nut 42 may then be threaded onto the bolt 18 (FIGS. 5 and 6). The nut 42 may be loosely tightened to allow the crank bar 16 to be adjusted or moved relative to the slide bracket 14. Once the crank bar 16 is positioned to the desired position relative to the slide bracket 14, the nut 42 may be tightened by a tool, such as a wrench, to rigidly secure the crank bar 16 relative to the adjustable slide bracket 14 and, thus, rigidly define the length of the adjustable handle assembly 10.

In another example, the fastener 18 may be a carriage bolt and the nut 42 may be a flange nut. A carriage bolt 18 may include square portion proximate to its head that may fit snuggly into the aperture 40 of the second linear portion 34, whereby the aperture 40 may be of a generally square shape (FIGS. 2 and 4A). Such a fit may generally resist rotation of the bolt 18 once its square portion is engaged with the square aperture 40, thereby, facilitating the tightening of the nut 42 either manually or with any appropriate type of tool. The flange nut 42 may include a flange portion that may engage with a surface of the crank bar 16 to further facilitate securing the crank bar 16 and the bracket 14. While the crank bar 16 may be described and illustrated as being dog-legged in shape, it is to be understood that the crank bar 16 may be otherwise arranged provided that it may be secured to the slide bracket 14, and the winch or jack, and allow for rotation of the adjustable handle assembly 10.

The handle grip 12 may be of any appropriate shape or size, such as a generally cylindrically shape (FIGS. 1, 2, 5 and 6). The handle grip 12 may be fabricated out of any appropriate type of materials, such that it provides a comfortable grip to the operator and facilitate ease of use of the handle 10. The handle grip 12 may be located at any appropriate position on the handle 10, such as adjacent the aperture 26 in the adjustable slide bracket 14.

The handle grip 12 may be attached to the slide bracket 14 by any appropriate means. For example, the handle grip 12 may be rotatably attached or otherwise secured to the slide bracket 14 by passing a fastener 20 through a central bore (not shown) in the grip 12 and also through the aperture 26 in the bracket 14. The fastener 20 may be secured with another fastener, such as a nut 30 (FIG. 2).

The fastener 20 may be of any appropriate shape, size or type, such as a screw, bolt or the like. For example, the fastener 20 may include a threaded shaft 46 and a head 28. The head 28 may be slightly larger than the shaft 46 and may abut the grip 12 at one end of the central bore to prevent the fastener 20 from passing all the way though the central bore and to position the fastener 20 relative to the grip 12 (FIG. 2). In such an arrangement, a portion of the threaded shaft 46 of the fastener 20 may extend through and out an end of the grip 12 located opposite of where the head 28 of the fastener 20 may abut the grip 12.

In such an arrangement, the portion of the fastener 20 extending out from the grip 12 may be passed through the aperture 26 located adjacent the end of the bracket 14 and the threaded nut 30, or other such securing mechanism, may be threaded onto the fastener 20 so that the handle grip 12 may be rotatably secured to the adjustable slide bracket 14. It is to be understood that the grip 12 may be rotatably attached or otherwise secured to the slide bracket 14 in any other variety of manners and should not be limited to that shown or described herein. For example, the grip 12 may be secured to the bracket 14 by a rivet, by a short threaded rod integrated with the grip 12 and extending from the grip 12, or the like.

The overall length of the handle assembly 10 may be adjusted by any appropriate means, such as by selectively securing the crank bar 16 to the adjustable slide bracket 14. For example, the adjustable positioning of the crank bar 16 relative to the slide bracket 14 may be facilitated by the pair of slots 22, 24 in the slide bracket 14. The fastener or bolt 18 may be used to secure the crank bar 16 to the bracket 14 via the first slot 22 (FIG. 5). The bolt 18 may also be used to secure the crank bar 16 to the bracket 14 via the second slot 24 (FIG. 6).

The overall length of the handle assembly 10 may generally be longer when the crank bar 16 is secured to the bracket 14 via the first slot 22 (FIG. 5), and the overall length of the handle assembly 10 may generally be shorter when the crank bar 16 is secured to the bracket 14 via the second slot 24 (FIG. 6). Therefore, the overall length of the handle assembly 10 may be adjusted by selectively securing the crank bar 16 to the bracket 14 via either the first slot 22 or the second slot 24.

In addition, within each slot 22, 24 the overall length of the handle assembly 10 may be further adjusted by sliding the bolt 18 along the length of the slot 22, 24, such as to the left or right (relative to FIGS. 5 and 6) within the first slot 22 or second slot 24. The aperture 40 in the second linear portion 34 of the crank bar 16 may be positioned at any desired location along the length of either the first slot 22 or the second slot 24.

For example, the aperture 40 may be located at the approximate midpoint of the first slot 22 (FIG. 5). It is to be understood that the bracket 14 may be slid so that the aperture 40 may be closer to the right portion (with respect to FIG. 5) of the first slot 22 to decrease the length of the handle assembly 10. Conversely, the bracket 14 may be slid so that the aperture 40 may be closer to the left portion (with respect to FIG. 5) of the first slot 22 to increase the length of the handle assembly 10.

In another example, the aperture 40 in the second linear portion 34 of the crank bar 16 may be positioned so that it may be approximately at the midpoint of the second slot 24 (FIG. 6). It is to be understood that the bracket 14 may be slid so that the aperture 40 may be closer to the right portion (with respect to FIG. 6) of the second slot 24 to decrease the length of the handle assembly 10. Conversely, the bracket 14 may be slid so that the aperture 40 may be closer to the left portion (with respect to FIG. 6) of the second slot 24 to increase the length of the handle assembly 10.

The handle assembly 10 may be arranged so that the bracket 14 may slide relative to the crank bar 16 by loosely threading the nut 42 onto the bolt 18. The bracket 14 may be rigidly fixed with respect to the crank bar 16 by the application of torque to the nut 42 or bolt 18 to sufficiently tighten the nut 42 onto the bolt 18. It is to be understood that to alter the overall length of the handle assembly 10 the nut 42 and bolt 18 combination may be loosened so that the adjustment bracket 14 may be slid relative to the crank bar 16.

For example, the handle assembly 10 may be arranged so that when the crank bar 16 is secured through the first slot 22 of the adjustable slide bracket 14, the overall length of the handle assembly 10 may be adjusted between any appropriate lengths, such as between approximately 9 inches and approximately 11 inches. The handle assembly 10 may also be arranged so that when the crank bar 16 is secured through the second slot 24 of the adjustable slide bracket 14, the overall length of the handle assembly 10 may be adjusted between any appropriate lengths, such as between approximately 6 inches and approximately 8 inches.

In such an arrangement, the overall length of the handle assembly 10 may be selectively varied between approximately 6 inches and approximately 11 inches. It is to be understood that a handle assembly may be arranged to accommodate adjustments over a wide range of overall lengths and should not be limited to those shown and described herein. For example, the slots 22, 24 in the adjustable slide bracket 14 may be increased or decreased in length, the number of slots 22, 24 in a slide bracket 14 may be increased or decreased, the length of the bracket 14 or crank bar 16 may be increased or decreased, additional apertures 40 may be formed in the crank bar 16 to increase the number of locations at which the crank bar 16 may be secured to the bracket 14, and the like.

In addition, while the handle assembly 10 is shown and described herein as being adjustable via slots 22, 24, it is to be understood that the handle assembly 10 may be adjustable via any other appropriate means, such as a via a ratcheting mechanism and the like, and should not be limited to that shown and described herein.

The adjustable handle 10 may be used with any appropriate type of apparatus, such as with winches or jacks, whereby the overall length of the handle 10 may be adjustable. Such arrangements may allow winch and jack handles 10 to be selectively shortened or lengthened to accommodate different winches or jacks or to accommodate different applications for a specific winch or jack. For example, when a winch is utilized to move large or heavy cargo, a relatively large force may be needed to pull or otherwise move the cargo onto a trailer.

The length of the handle 10 may be increased to increase the force applied to the cargo to move or maneuver the cargo. The lengthening of the handle 10 may provide a longer lever arm, thus, allowing the winch operator to apply a greater pulling force on the cargo without substantially increasing the effort put forth by the operator to rotate the handle 10. Similarly, when a jack is utilized to support a trailer that is holding a heavy load, a relatively large force may be needed to raise the trailer to a horizontal position. The length of the handle 10 may be increased to increase the force applied to the trailer when the jack operator rotates the handle 10. Such an arrangement may assist the jack operator in raising and lowering a trailer.

In another example, a winch may be situated in a position that offers limited space around the winch, and thus, offers limited clearance for the handle 10 to be rotated. In such an arrangement, the handle 10 may be shortened to accommodate rotation of the handle 10 within the tight space or limited clearance without the handle 10 interfering with surrounding objects or surfaces. Similarly, a jack situated in a position with limited space and clearance may utilize a shortened handle 10 to operate in the limited space and clearance.

Arranging a handle 10 for a winch or jack so that the overall length of the handle 10 may be adjustable provides for greater flexibility in manufacturing and inventorying of such handles 10. For example, an adjustable winch or jack handle 10 may reduce the number of variations or types of non-adjustable handles that must be produced to satisfy the need for the numerous applications of winch and jack handles. In addition, adjustable handles 10 may reduce the number of variations or types of non-adjustable handles that must be inventoried by a manufacture or distributor to satisfy the need for the numerous applications of winch and jack handles.

Although the embodiments have been illustrated in the accompanying drawings and described in the foregoing detailed description, it is to be understood that the present application or claims are not to be limited to just the embodiments disclosed, but that the disclosed apparatus may be capable of numerous rearrangements, modifications and substitutions without departing from the scope of the claims hereafter.

Having thus described the invention, I claim:

1. An adjustable handle assembly comprising:
a crank bar including an attachment aperture located towards a first end and an adjustment aperture located towards a second end, wherein said attachment aperture is attachable to a shaft of a winch or jack;
a slide bracket including at least one slot and a grip aperture, wherein said slide bracket is capable of engagement with said crank bar forming an overall length of said handle assembly;
a grip attachable to said grip aperture;
wherein said crank bar is slidable along said at least one slot.

2. The handle assembly of claim 1, wherein the shaft is capable of driving a drum of the winch or jack.

3. The handle assembly of claim 1, wherein said crank bar is attached to said slide bracket with at least one fastener.

4. The handle assembly of claim 1, wherein said grip is rotatably attached to said slide bracket with at least one fastener.

5. The handle assembly of claim 1, wherein said slide bar includes a first slot and a second slot.

6. The handle assembly of claim 5, wherein said slots are located adjacent to one another.

7. The handle assembly of claim 5, wherein the overall length of said handle assembly is longer when said crank bar is secured to said slide bracket via said first slot and the overall length of said handle assembly is shorter when said crank bar is secured to said slide bracket via said second slot.

8. The handle assembly of claim 7, wherein said crank bar is adjustable along a length of said slots wherein the overall length of said handle assembly is adjustable along the length of said slots.

9. The handle assembly of claim 5, wherein said adjustment aperture of said crank bar is positionable at any location along the length of either of said first slot or said second slot.

10. The handle assembly of claim 9, wherein said crank bar is secured through said first slot the overall length of said handle assembly is adjustable between about 9 and about 11 inches.

11. The handle assembly of claim 9, wherein said crank bar is secured through said second slot the overall length of said handle assembly is adjustable between about 6 and about 8 inches.

12. The handle assembly of claim 9, wherein the overall length of said handle assembly is adjustable between about 6 and about 11 inches.

13. A handle assembly for adjusting a winch or jack comprising:
a crank bar including an adjustment aperture;
a slide bracket including a first slot and a second slot, wherein said slide bracket is capable of engagement with said crank bar;
at least one fastener capable of engagement with said adjustment aperture and either said first slot or said second slot;
wherein said crank bar is adjustable along a length of said first slot; and
wherein said crank bar is adjustable along a length of said second slot.

14. The handle assembly of claim 13, wherein an attachment aperture that is attachable to a shaft of the winch or jack

15. The handle assembly of claim 14, wherein the shaft is capable of driving a drum of the winch or jack.

16. The handle assembly of claim 13, wherein said crank bar is S-shaped.

17. The handle assembly of claim 13, wherein said slide bracket includes a grip aperture that is capable of rotatable attachment to a grip.

18. The handle assembly of claim 15, wherein said first slot lengthens said handle assembly and increases a force applied to the winch or jack.

19. The handle assembly of claim 15, wherein said second slot shortens said handle assembly to accommodate rotation of said handle assembly within a space with limited clearance.
